(19) United States
(12) Patent Application Publication
(10) Pub. No.: US 2015/0117270 A1
(43) Pub. Date: Apr. 30, 2015

(54) METHOD AND APPARATUS FOR DETERMINING GUARD PERIOD ON TIME DIVISION DUPLEX SYSTEM

(71) Applicant: ELECTRONICS AND TELECOMMUNICATIONS RESEARCH INSTITUTE, Daejeon (KR)

(72) Inventors: Jung Sun UM, Daejeon (KR); Byung Jang JEONG, Daejeon (KR); Sung Hyun HWANG, Daejeon (KR); Hoi Yoon JUNG, Daejeon (KR); Jae Ick CHOI, Daejeon (KR)

(21) Appl. No.: 14/520,401

(22) Filed: Oct. 22, 2014

(30) Foreign Application Priority Data
Oct. 31, 2013 (KR) 10-2013-0131311
Mar. 4, 2014 (KR) 10-2014-0025656

(51) Int. Cl. H04L 5/14; H04W 72/04; H04L 5/00

(52) U.S. Cl. CPC H04L 5/1461; H04L 5/0053; H04W 72/042; H04W 72/0446
USPC 370/278

(57) ABSTRACT

Disclosed are a method and an apparatus for determining a Guard Period (GP) in a Time Division Duplexing (TDD) system. A communication method based on Time Division Duplexing (TDD) includes: determining, by a base station, a guard period based on information on a distance between user equipment and the base station; and performing, by the base station, downlink transmission to the user equipment based on the determined guard period, wherein the guard period is determined based on one of a default guard period mode, a reduced guard period mode, and a zero guard period mode, and the reduced guard period mode is a mode for setting a reduced guard period, which is shorter than the default guard period set based on the default guard period mode, and the zero guard period mode is a mode for setting a length of the guard period to 0.

### CROSS-REFERENCE TO RELATED APPLICATIONS

This application is based on and claims priority from Korean Patent Application Nos. 10-2013-0131311, filed on Oct. 31, 2013 and 10-2014-0025656, filed on Mar. 4, 2014 with the Korean Intellectual Property Office, the disclosure of which is incorporated herein in its entirety by reference.

### BACKGROUND

1. Field

The present invention relates to wireless communication, and more particularly, to a Long Term Evolution (LTE) system operated in a Time Division Duplex (TDD) method.

2. Discussion of Related Art

LTE is an abbreviation of Long Term Evolution, and is technology for improving a transmission rate and efficiency of 3^{rd}-generation (3G) mobile communication technology by 3^{rd} Generation Partnership Project (3GPP) 3. The initial LTE (Release 8/9) is slightly insufficient compared to the technical conditions of 4G regulated by International Telecommunication Union (ITU) to be called 3.9G technology. Then, LTE-Advanced (Release 10) which is further advanced LTE technology satisfies the technical conditions of 4G regulated by ITU to be considered as 4G.

4G mobile communication technologies commonly use an Orthogonal Frequency-Division Multiple Access (OFDMA) method as a multiple access method, and uses Multiple Input Multiple Output (MIMO) technology as antenna technology. The LTE and the LTE-Advanced are also based on the OFMDA and the MIMO.

In a mobile communication system, a wireless link for transmission to a base station by a terminal is referred to as an uplink, and a wireless link for reception from a base station by a terminal is referred to as a downlink, and the discrimination between the transmission and the reception is referred as duplexing. A duplexing scheme includes a Frequency Division Duplexing (FDD) scheme for assigning separate frequency bands to the uplink and the downlink, and a Time Division Duplexing (TDD) scheme for temporally dividing the uplink and the downlink in one frequency band. The standard of the LTE technology includes both the FDD scheme and the TDD scheme.

Since the technology standard of the LTE is not separately divided for the FDD and the TDD, the LTE-TDD conforms to the technical standard of the LTE. A highest data rate of the LTE-TDD is different according to a time ratio assigned to the uplink and the downlink. The TDD has strength and a weakness in comparison with the FDD, and first, the TDD is flexible so that a proportion of the downlink and the uplink is adjustable depending on a situation. When it is assumed that the amount of traffics received by a terminal is considerably greater than the amount of traffics transmitted by the terminal based on a line with a bandwidth of 40 MHz, in the TDD scheme, most parts of the entire time are allocated to the downlink to increase a reception rate.

### SUMMARY

The present invention has been made in an effort to provide a method of determining a Guard Period (GP) in a TDD system.

Further, the present invention has been made in an effort to provide a device for supporting a method of determining a GP in a TDD system.

An exemplary embodiment of the present invention provides a communication method based on Time Division Duplexing (TDD), including: determining, by a base station, a guard period based on information on a distance between user equipment and the base station; and performing, by the base station, downlink transmission to the user equipment based on the determined guard period, wherein the guard period is determined based on one of a default guard period mode, a reduced guard period mode, and a zero guard period mode, and the reduced guard period mode is a mode for setting a reduced guard period, which is shorter than the default guard period set based on the default guard period mode, and the zero guard period mode is a mode for setting a length of the guard period to 0. The communication method may further include, when the guard period is the reduced guard period, the base station determines a downlink resource allocated for the downlink transmission based on the information on the distance between the user equipment and the base station. When the guard period is the reduced guard period or a guard period having a length of 0, the base station may transmit special subframe format information, the special subframe format information may include information about a frame to which the reduced guard period mode or the zero guard period mode is applied, and the special subframe format information may include information about a special subframe, in which the reduced guard period mode or the zero guard period mode is used, among the special subframes included in the frame. When the number of special subframes is plural, lengths of the guard periods defined in the respective special frames among the special subframes may have different values. A size of the reduced guard period may be set based on a Round Trip Time (RTT) of the user equipment. The communication method may further include: when the reduced guard period mode or the zero guard period mode is used, transmitting, by the base station, information about a reduced guard period based on the default guard period to the user equipment, and receiving, by the base station, information about whether the user equipment accepts the reduced guard period, from the user equipment.

Another exemplary embodiment of the present invention provides a base station performing a communication method based on TDD, including: a Radio Frequency (RF) unit configured to transmit or receive a radio signal; and a processor selectively connected with the RF unit to be operated, wherein the processor determines a guard period based on information on a distance between user equipment and the base station, and performs downlink transmission to the user equipment based on the determined guard period, and the guard period is determined based on one of a default guard period mode, a reduced guard period mode, and a zero guard period mode, and the reduced guard period mode is a mode for setting a reduced guard period, which is shorter than the default guard period set based on the default guard period mode, and the zero guard period mode is a mode for setting a length of the guard period to 0. When the guard period is the reduced guard period, the processor may determine a downlink resource allocated for the downlink transmission based on the information on the distance between the user equipment and the base station. When the guard period is the reduced guard period or a guard period having a length of 0, the base station may transmit special subframe format information, the special subframe format information may include information about a frame to which the reduced guard period mode or the zero guard period mode is applied, and the special subframe format information may include information about a special subframe, in which the reduced guard period mode or the zero guard period mode is used, among the special subframes included in the frame. When the number of special subframes is plural, lengths of the guard periods defined in the respective special frames among the special subframes may have different values. A size of the reduced guard period may be set based on a Round Trip Time (KIT) of the user equipment. When the reduced guard period mode or the zero guard period mode is used, the processor may transmit information about a reduced guard period based on the default guard period to the user equipment, and receive information about whether the user equipment accepts the reduced guard period from the user equipment.

As described above, according to the method and the apparatus for determining a GP in the TDD system, it is possible to transmit and receive data between user equipment and a base station based on a frame using a reduced GP or a frame using no GP according to a distance between the user equipment and the base station. By using the method, it is possible to prevent unnecessary waste of time resources and improve data transmission efficiency.

Further, the present invention may be usefully applied to a small cell environment, such as an indoor side, having small cell coverage, a Cognitive Radio (CR) system, which transmits location information about the user equipment, and a system in which the TDD and the FDD are simultaneously operated, and may increase a capacity of a system by using a minimized GP.

In addition, when a service, in which bilateral communication, such as Machine to Machine (M2M) communication, is frequently performed with a short period is operated based on the TDD, it is possible to perform communication based on a frame structure, in which resource loss is minimized by a GP, by using the GP determining method according to the exemplary embodiment of the present invention.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a conceptual diagram illustrating downlink transmission and uplink transmission based on TDD;

FIG. 2 is a conceptual diagram illustrating a frame structure used in a TDD system;

FIG. 3 is a conceptual diagram illustrating data transmission and reception operations between user equipment and a base station in the TDD system according to an exemplary embodiment of the present invention;

FIG. 4 is a conceptual diagram illustrating a method of operating a guard period in the TDD system according to an exemplary embodiment of the present invention;

FIG. 5 is a conceptual diagram illustrating a method of operating a guard period in the TDD system according to an exemplary embodiment of the present invention;

FIG. 6 is a conceptual diagram illustrating a method of receiving information about a special subframe according to an exemplary embodiment of the present invention;

FIG. 7 is a conceptual diagram illustrating an operation of the TDD system according to an exemplary embodiment of the present invention;

FIG. 8 is a conceptual diagram illustrating a data transmission and reception method between user equipment and a base station in the TDD system according to an exemplary embodiment of the present invention;

FIGS. 9 and 10 are conceptual diagrams illustrating communication between a base station and user equipment supporting FDD and TDD according to an exemplary embodiment of the present invention;

FIG. 11 is a conceptual diagram illustrating a method of determining a length of a guard period according to a position of user equipment according to an exemplary embodiment of the present invention;

FIG. 12 is a conceptual diagram illustrating a frame structure according to an exemplary embodiment of the present invention; and

FIG. 13 is a block diagram illustrating a wireless communication system according to an exemplary embodiment of the present invention.

### DETAILED DESCRIPTION

The present invention may have various modifications and various exemplary embodiments and specific exemplary embodiments will be illustrated in the drawings and described in detail in the detailed description. However, it is not intended to limit the present invention to the specific embodiments, and it will be appreciated that the present invention includes all modifications, equivalences, or substitutions included in the spirit and the technical scope of the present invention. In the description of respective drawings, similar reference numerals designate similar elements.

Terminologies such as first or second may be used to describe various components but the components are not limited by the above terminologies. The terms are used only to discriminate one constituent element from another constituent element. For example, without departing from the scope of the invention, a first constituent element may be named as a second constituent element, and similarly a second constituent element may be named as a first constituent element. A term “and/or” includes a combination of multiple relevant described items or any one of the multiple relevant described items.

It should be understood that when one constituent element referred to as being “coupled to” or “connected to” another constituent element, one constituent element can be directly coupled to or connected to the other constituent element, but intervening elements may also be present. By contrast, when one constituent element is “directly coupled to” or “directly connected to” another constituent element, it should be understood that there are no intervening element present.

Terms used in the present application are used only to describe specific exemplary embodiments, and are not intended to limit the present invention. Singular expressions used herein include plurals expressions unless they have definitely opposite meanings. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other specific characteristics, numbers, steps, operations, constituent elements, and components, or a combination thereof in advance.

Hereinafter, an exemplary embodiment of the present invention will be described in detail with reference to the accompanying drawings. Like reference numerals refer to like elements even though like elements are shown in different drawings, and an overlapping description of the same constituent element will be omitted.

A wireless device may be fixed or mobile, and may be called different terms, such as User Equipment (UE), a Mobile Station (MS), a Mobile Terminal (MT), a User Terminal (UT), a Subscriber Station (SS), a Personal Digital Assistant (PDA), a wireless modem, a handheld device, a terminal, and a wireless terminal. The wireless device may be a device supporting only data communication, such as a Machine-Type Communication (MTC) device.

The base station generally refers to a fixed station that communicates with a wireless device, and may be called different terms, such as an evolved-NodeB (eNB), a Base Transceiver System (BTS), and an Access Point (AP).

Hereinafter, operations of user equipment and/or a base station in the 3^{rd} Generation Partnership Project (3GPP) Long Term Evolution (LIE) or the 3GPP Long Term Evolution-Advanced (LTE-A) defined based on respective releases of the 3GPP Technical Specification (TS) will be described. Further, the present invention may be applied to various wireless communication networks, not the 3GPP LTE/3GPP LTE-A. Hereinafter, the LTE includes the LTE and/or the LTE-A.

In a mobile communication system, bilateral (downlink and uplink) communication may be performed by defining a duplex method so as to prevent interference between signals transmitted by a base station and user equipment.

The division of an uplink and a downlink based on a frequency domain is referred to as Frequency Division Duplexing (FDD), and the division of an uplink and a downlink in a time domain is referred to as Time Division Duplexing (TDD).

For the TDD, there is a guard time or a guard period in which data is not transmitted between a downlink and an uplink according to a cell service coverage of a base station. Hereinafter, the term, a guard period or a GP, are used for description in the exemplary embodiment of the present invention.

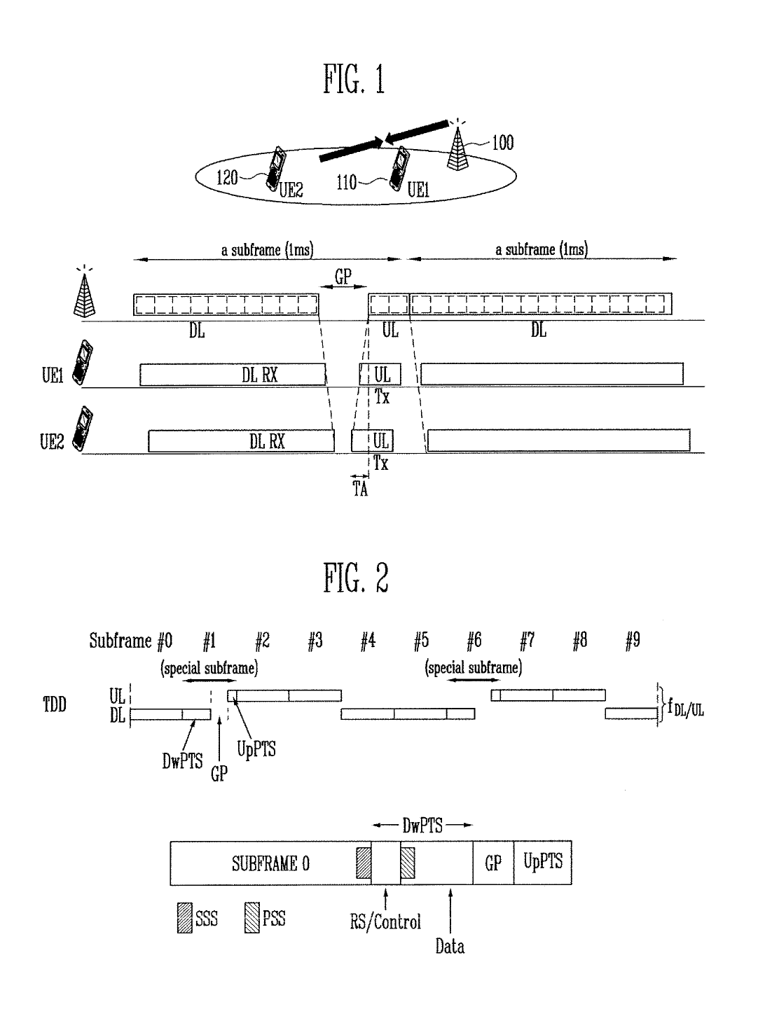

FIG. 1 is a conceptual diagram illustrating downlink transmission and uplink transmission based on TDD.

FIG. 1 illustrates a method of transmitting and receiving, by a base station 100, data with first user equipment 110 located around the base station and second user equipment 120 located at a boundary of a cell based on a TDD scheme.

A Guard Period (GP) may be set so that the base station and the user equipment do not interfere with each other when performing uplink transmission and downlink transmission. This may be processed by advancing an uplink timing in the user equipment so that a subframe of the last uplink just before a switch time between the uplink and the downlink is ended before a subframe of the first downlink after the switch starts. The uplink transmission timing of each user equipment may be controlled by the base station by using a Timing Advance (TA) function. The GP needs to be sufficiently long so that the user equipment receives downlink transmission from the base station and then switches the received transmission to the transmission to start temporally advanced uplink transmission. The TA may mean a time at which the user equipment needs to perform transmission in advance because the user equipment is distant from the base station.

Referring to FIG. 1, the first user equipment 110 is close to the base station 100, so that a delay for the downlink transmission and the uplink transmission is not large. However, the second user equipment 120 is located at the boundary of the cell, so that a delay in reception of downlink data from the base station 100 is large, and the TA for the uplink transmission is also large. Further, the second user equipment 120 needs to perform the uplink transmission to the base station 100 within the defined GP, so that a processing time for the uplink transmission is relatively decreased.

That is, a size of the GP defined in the TDD system may be increased in order to support the user equipment located at the boundary of the cell as a radius of the cell is increased. The increase in the size of the GP may cause the decrease in the amount of data usable for the uplink and the downlink by a special subframe, and a decrease in a capacity of the system.

FIG. 2 is a conceptual diagram illustrating a frame structure used in a TDD system.

In the TDD system, only one carrier wave frequency exists, and uplink transmission and downlink transmission are temporally divided based on one cell.

Referring to FIG. 2, some of the subframes may be allocated to the downlink transmission and some of the subframes may be allocated to the uplink transmission. In a special subframe, a switch between the downlink transmission and the uplink transmission may be incurred in the subframe. In the special subframe, various asymmetric setting may be present between the downlink transmission and the uplink transmission according to the amount of resources allocated to the downlink transmission and the uplink transmission.

The same carrier wave is used in the uplink transmission and the downlink transmission, so that both the base station and the user equipment need to switch from transmission to reception and from reception to transmission. The switch may be performed in the special subframe which is divided into a downlink part (DwPTS) 200, a guard period (GP) 210, and an uplink part (UpPTS) 220.

The DwPTS 200 has a smaller length allocated compared to a general downlink subframe, so that the amount of transmittable downlink data is small, but is essentially the same as that of the general downlink subframe. However, the UpTPS 220 is very short, so that the UpTPS 220 is not used in the data transmission, and instead, may be used in channel sounding or random access. Further, the UpTPS 220 may be vacant for the purpose of providing a longer GP.

In order to support various TDD system establishment scenarios, the setting values of the guard period need to be sufficiently various. In the existing TDD system, various combinations of setting values of the DwPTS, the GP, and the UpTPS may be supported as represented in Table 1 below.

TABLE 1

| | Normal CP | | | Extended CP | | |
|---|---|---|---|---|---|---|
| Format | DwPTS | GP | UpPTS | DwPTS | GP | UpPTS |
| 0 | 3 | 10 | 1 | 3 | 8 | 1 |
| 1 | 9 | 4 | | 8 | 3 | |
| 2 | 10 | 3 | | 9 | 2 | |
| 3 | 11 | 2 | | 10 | 1 | |
| 4 | 12 | 1 | | 3 | 7 | 2 |
| 5 | 3 | 9 | 2 | 8 | 2 | |
| 6 | 0 | 9 | 3 | 9 | 1 | |
| 7 | 10 | 2 | | | | |
| 8 | 11 | 1 | | | | |

Hereinafter, in the exemplary embodiment, a method of defining a GP decrease control determination parameter capable of decreasing a guard period in the 3GPP LIE TDD standard, and minimizing the guard period according to resource allocation for each user equipment will be described.

A length of a general OFDM symbol including a Cyclic Prefix (CP) of the 3GPP LIE standard is about 71.428 us. A size of a cell to be covered by the GP based on the length of the CP of the OFDM symbol may have values represented in Table 2.

TABLE 2

Normal CP (us, Km)

| OFDM Sym. | Duration | Cell coverage |
|---|---|---|
| 1 | 71.42857143 | 10.71428571 |
| 2 | 142.8571429 | 21.42857143 |
| 3 | 214.2857143 | 32.14285714 |
| 4 | 285.7142857 | 42.85714286 |
| 9 | 642.8571429 | 96.42857143 |
| 10 | 714.2857143 | 107.1428571 |

Extend CP (us, Km)

| OFDM Sym. | Duration | Cell coverage |
|---|---|---|
| 1 | 83.33333333 | 12.5 |
| 2 | 166.6666667 | 25 |
| 3 | 250 | 37.5 |
| 7 | 583.3333333 | 87.5 |
| 8 | 666.6666667 | 100 |

Referring to Table 2, it is assumed that in the LTE system, the smallest cell coverage is about 10 km. An indoor environment may be operated with a small cell having coverage smaller than 200 m. In the small cell environment, a round trip time of 2 us or smaller may be consumed.

The round trip time is smaller than 5 us which is the length of the normal CP of the OFDM symbol, and may be determined as a channel delay effect of a signal received from the user equipment in the position of the base station operated by the TDD system. Accordingly, in a small cell environment of an indoor area in which the size of the cell is small, the system may be operated even without the guard period.

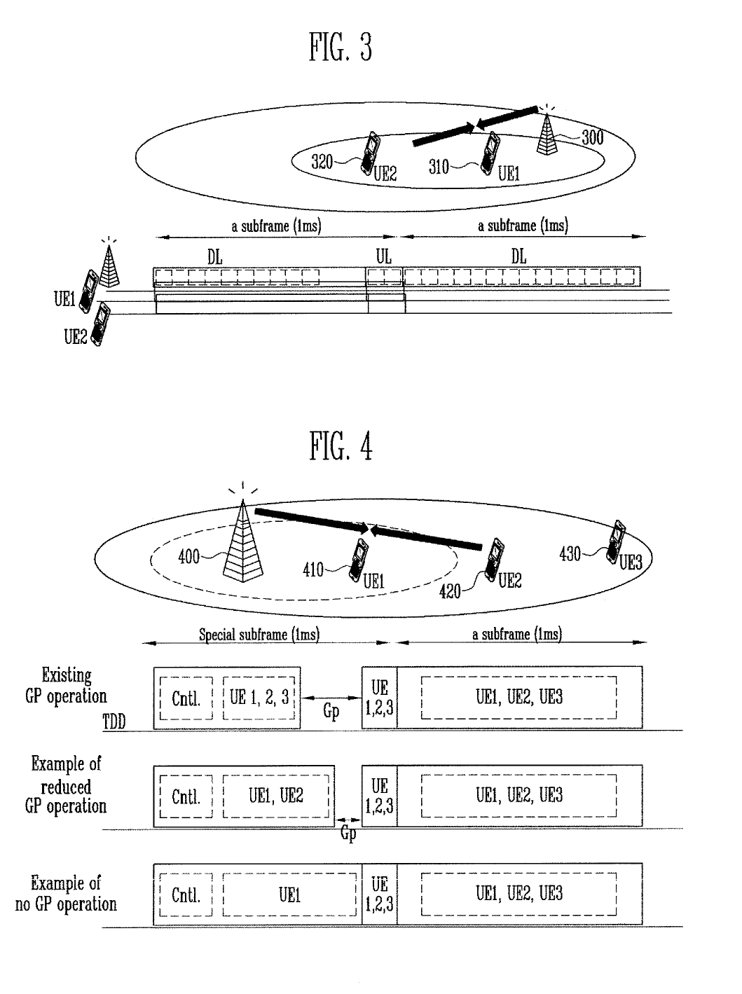

FIG. 3 is a conceptual diagram illustrating data transmission and reception operations between user equipment and a base station in the TDD system according to an exemplary embodiment of the present invention.

Referring to FIG. 3, a case where a base station 300 implements a small cell, and first user equipment 310 and second user equipment 320 transmit and receive data with the base station 300 in a small cell area. When data transmission and reception are performed between the base station 300 and the user equipment 310 and 320 in a small cell or an area adjacent to the base station 300, a guard period for switch between uplink data and downlink data may not be used. That is, for the small cell, a round trip time is small, so that even though the guard period is not present, the base station 300 may transmit data through a downlink and then determine received uplink data with data received with a channel delay. Accordingly, the switch may be performed between the downlink transmission and the uplink transmission or the uplink transmission and the downlink transmission even though a separate guard period is not included in a special subframe.

In the exemplary embodiment of the present invention, a format of a new special subframe usable in a small cell environment is disclosed. Table 3 below represents formats of the new special subframe usable in the small cell environment.

TABLE 3

| | Normal CP | | | Extended CP | | |
|---|---|---|---|---|---|---|
| Format | DwPTS | GP | UpPTS | DwPTS | GP | UpPTS |
| 0 | 3 | 10 | 1 | 3 | 8 | 1 |
| 1 | 9 | 4 | | 8 | 3 | |
| 2 | 10 | 3 | | 9 | 2 | |
| 3 | 11 | 2 | | 10 | 1 | |
| 4 | 12 | 1 | | 3 | 7 | 2 |
| 5 | 3 | 9 | 2 | 8 | 2 | |
| 6 | 9 | 3 | | 9 | 1 | |
| 7 | 10 | 2 | | — | — | — |
| 8 | 11 | 1 | | — | — | — |
| 9 | 13 | 0 | 1 | — | — | — |
| 10 | 12 | 0 | 2 | — | — | — |

Referring to Table 3, special subframe format 9 and special subframe format 10, in which a guard period is not defined, may be newly defined to be usable in a period in which downlink and uplink are switched.

When the downlink of the special frame is allocated only to some user equipment 310 and 320 (for example, the user equipment located within a predetermined distance in coverage of the base station 300) in a macro cell, as well as the small cell, special subframe format 9 and special subframe format 10, in which the guard period is not defined, may be usable. The reason is that the uplink transmitted by the user equipment far from the base station, such as a boundary of a cell, may not be operated due to interference until the user equipment located at the vicinity of the base station 300 receives information from the base station.

Otherwise, the switch between the uplink transmission and the downlink transmission may be performed by using a reduced GP, which has a shorter distance than that of an existing guard period, in consideration of a wide coverage of the macro cell.

FIG. 4 is a conceptual diagram illustrating a method of operating a guard period in the TDD system according to an exemplary embodiment of the present invention.

FIG. 4 illustrates a method of performing switch between uplink and downlink by using a reduced guard period or without using a guard period according to a distance to user equipment when a base station 400 performs downlink transmission.

An upper end of FIG. 4 displays positions between a base station 400 and a plurality of user equipment 410, 420, and 430. First user equipment 410 may be user equipment located in a first area within coverage of the base station 400, second user equipment located between the first area and the a boundary area of the coverage of the base station, and third user equipment 430 may be user equipment located in a boundary area of the coverage of the base station.

An existing guard period operation scheme, which is the TDD scheme at the first part in a lower end of FIG. 4, is the case where the existing guard period is used. The existing guard period may be operated by setting the guard period so that the uplink data transmitted by the user equipment 410, 420, and 430 do not overlap the downlink data transmitted by the base station 400 regardless of the distances to the user equipment 410, 420, and 430. When the downlink data is transmitted to the user equipment, such as the third user equipment 430, located at the boundary of the coverage of the base station 400, it is possible to prevent the downlink transmission and the uplink transmission from colliding with each other in the TDD system by using the existing guard period.

A reduced guard period operation scheme, which is the TDD scheme at the second part in the lower end of FIG. 4, is the case where the reduced guard period is used. For example, when the user equipment 410 and 420 are located in a predetermined area within the coverage of the base station 400, it is possible to improve efficiency of the wireless resource by using the reduced guard period. When the reduced guard period is used, the downlink transmission to the user equipment located at the boundary of the coverage of the base station 400, such as the third user equipment 430, may not be performed. That is, the allocation of the resource for the downlink transmission to the user equipment 430, which is distant from the base station 400 by the predetermined distance or longer, may be limited in the special subframe. A size of the reduced guard period may be set based on a round trip time of the user equipment. A guard period removing operation scheme, which is the TDD scheme at the third part in the lower end of FIG. 4, is the case where a guard period is not used. For example, when the user equipment 410 is located at a predetermined area close to the base station 400, the base station 400 may determine the received uplink after the transmission of the downlink as a signal having a delay by a channel delay. Accordingly, the switch may be performed between the downlink transmission and the uplink transmission or the uplink transmission and the downlink transmission even though a separate guard period is not defined in the special subframe. For example, when the downlink transmission is performed only in the user equipment 410 located in the area close to the base station 400 as illustrated in FIG. 1, the base station 400 and the user equipment may communicate with each other without defining the guard period in the special subframe.

As an example of the operation of the base station, the base station may determine a guard period based on information on a distance between the user equipment and the base station. Further, the base station may perform downlink transmission to the user equipment based on the determined guard period. The guard period may be determined based on one of a default guard period mode, a reduced guard period mode, and a zero guard period mode, and the reduced guard period mode may be a mode for setting a reduced guard period, which is shorter than the default guard period set based on the default guard period mode, and the zero guard period mode may be a mode for setting a length of the guard period to 0.

When the guard period is the reduced guard period, the base station may determine a downlink resource allocated for the downlink transmission based on the information on the distance between the user equipment and the base station. For example, according to the exemplary embodiment of the present invention, a part of the OFDM symbol in the DwPTS may be allocated to the user equipment according to the distance between the user equipment and the base station. The ePDCCH may be a control channel used for allocating a source for transmitting downlink data to the user equipment.

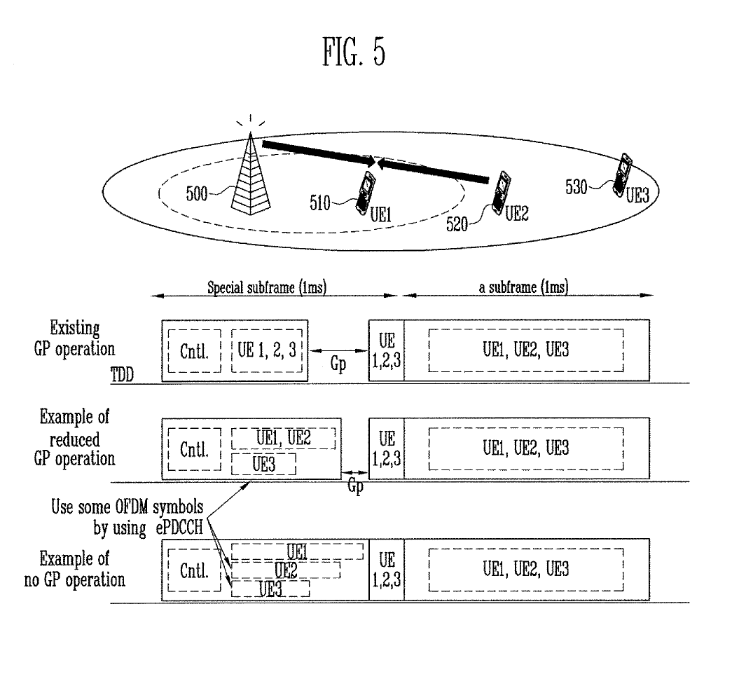

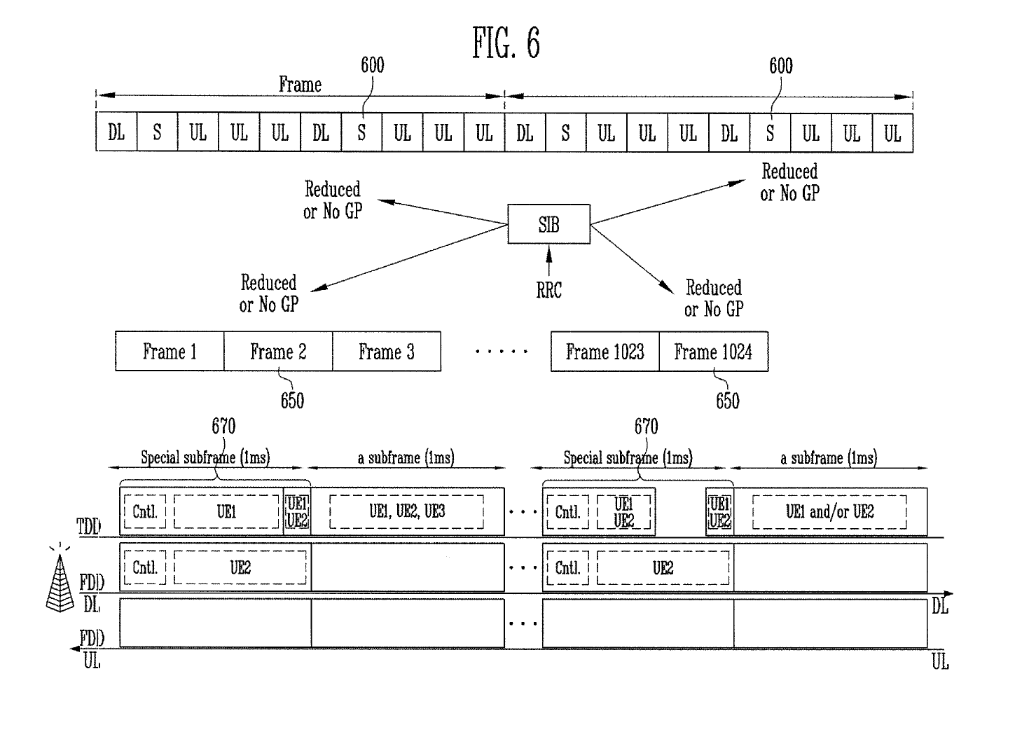

FIG. 5 is a conceptual diagram illustrating a method of operating a guard period in the TDD system according to an exemplary embodiment of the present invention.

FIG. 5 illustrates a method in which a reduced guard period is used or a guard period is not used by differently setting a downlink OFDM symbol allocated for downlink transmission according to user equipment when a base station 500 performs downlink transmission.

An upper end of FIG. 5 displays positions between a base station 500 and a plurality of user equipment 510, 520, and 530. First user equipment 510 may be user equipment located in a first area within coverage of the base station 500, second user equipment located between the first area and a boundary area of the coverage of the base station, and third user equipment 530 may be user equipment located in the boundary area of the coverage of the base station.

An existing guard period operation scheme, which is the TDD scheme at the first part in a lower end of FIG. 5, is the case where the existing guard period is used. The existing guard period may be operated by setting a guard period so that uplink data transmitted by the user equipment 510, 520, and 530 do not overlap the downlink data transmitted by the base station 500 regardless of the distances to the user equipment 510, 520, and 530. When the downlink data is transmitted to the user equipment, such as the third user equipment 530, located at the boundary of the coverage of the base station 500, it is possible to prevent the downlink transmission and the uplink transmission from colliding with each other in the TDD system by using the existing guard period in the special subframe.

A reduced guard period operation scheme, which is the TDD scheme at the second part in the lower end of FIG. 5, is the case where a reduced guard period is used. In order to use a reduced guard period, an OFDM symbol for performing downlink transmission to the user equipment may be variously set according to distances between the user equipment 510, 520, and 530, and the base station 500. For example, for the user equipment, such as the third user equipment 530, located at the boundary of the coverage of the base station, the number of OFDM symbols allocated for the downlink based on the ePDCCH may be limited. By using the downlink resource limiting method according to the position of the user equipment, it is possible to prevent the downlink transmission and the uplink transmission from colliding with each other even though the reduced guard period is used. A size of the reduced guard period may be set based on an RTT of the user equipment.

A guard period removing operation scheme, which is the TDD scheme at the third part in the lower end of FIG. 5, is the case where the guard period is not used. In order not to use the guard period, an OFDM symbol for performing downlink transmission to the user equipment 510, 520, and 530 may be variously set according to distances between the user equipment 510, 520, and 530, and the base station 500. For example, for the user equipment, such as the second user equipment 520, located between the first area and the boundary region of the coverage of the base station, a resource for downlink transmission may be allocated up to a first OFDM symbol based on the ePDCCH. Further, for the user equipment, such as the third user equipment 530, located in the boundary region of the coverage of the base station, a resource for downlink transmission may be allocated up to a second OFDM symbol based on the ePDCCH. As the distances between the base station 500 and the user equipment 510, 520, and 530 are increased, the number of OFDM symbols which the base station 500 allocates to the user equipment 510, 520, and 530 for the downlink transmission may be decreased.

According to another exemplary embodiment of the present invention, in order to operate a minimal guard period (the reduced guard period or the guard period is not used), a Special Subframe Format (SSF) may be adaptively allocated for each frame.

The user equipment may obtain information about the SSF to be used based on information, such as a System Information Block (SIB). For example, the user equipment may semi-statically receive the information about the SSF from an RRC in the unit of a frame or a subframe. For example, the user equipment may check a frame index through initial access, and check a position (index) of a frame including the special subframe, in which the reduced guard period or the guard period is not used, through the SIB.

Further, the user equipment may obtain information about the guard period used in the special subframe included in each frame. The guard period may not be allocated to all of the special subframes included in each frame, or the guard period may be allocated to only a special subframe among the special subframes included in each frame. For example, for the TDD based frame setting of 0, 1, 2, and 6, the guard period may not be used only in one special subframe between the two special subframes included in the frame.

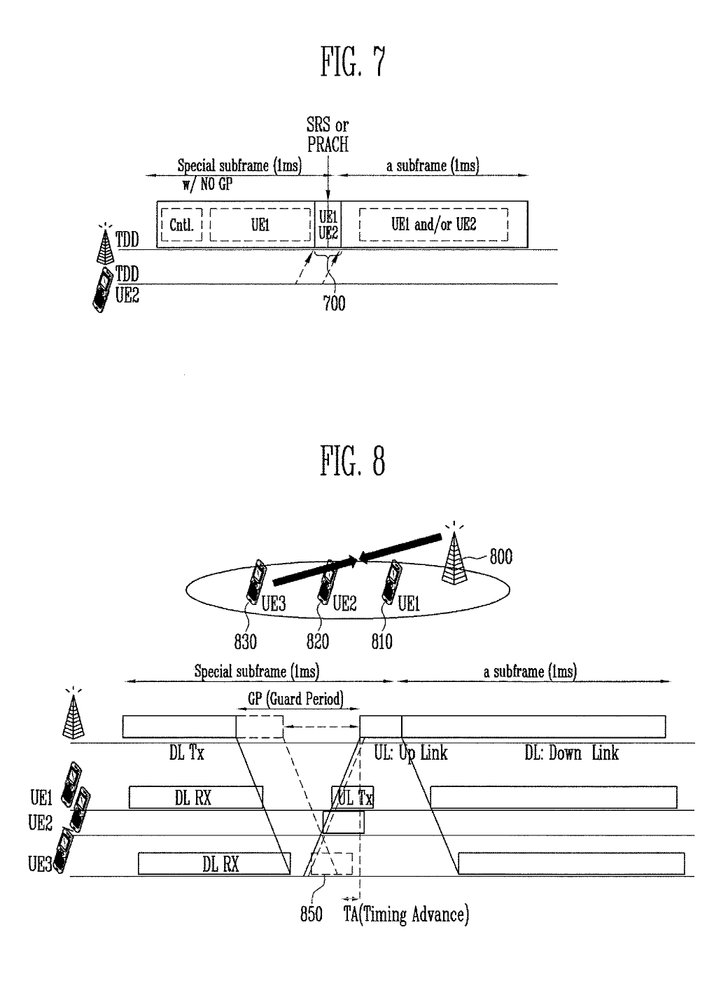

FIG. 6 is a conceptual diagram illustrating a method of receiving information about a special subframe according to an exemplary embodiment of the present invention.

Referring to an upper end of FIG. 6, user equipment may receive data (for example, SIB) including information about a special subframe from a higher layer (for example, an RRC). Hereinafter, the information about the special subframe received from a higher layer by the user equipment may be defined as a term, special subframe format information to be used.

The special subframe format information may include information on an index of a frame in which a reduced guard period or the guard period is not used, information about the special subframe, in which the reduced guard period or the guard period is not used, among the special subframes included in the corresponding frame, and the like. When the number of special subframes is plural, lengths of the guard periods defined in the respective special frames among the special subframes may have different values.

As illustrated in the upper end of FIG. 6, the user equipment may recognize whether a currently received frame uses the reduced guard period or the guard period based on information on an index of the frame 650 in which the reduced guard period or the guard period is not used. Further, the user equipment may obtain information about a special subframe 600, in which a reduced guard period is used or a guard period is not used, among the special subframes included in a corresponding frame.

Referring to a lower end of FIG. 6, uplink transmission and downlink transmission may be switched without considering a guard period for a specific subframe 670 indicated as a guard period is not present in the TDD system. By contrast, uplink transmission and downlink transmission may be switched considering a guard period for a specific subframe 690 indicated as a guard period is present.

According to yet another exemplary embodiment of the present invention, a UpTPS, which is a period for transmitting uplink data in the special subframe may be defined by one or two Single Carrier (SC)-Frequency Division Multiple Access (FDMA) symbols. When the UpTPS is defined by one SC-FDMA symbol, the user equipment may transmit only a Sounding Reference Signal (SRS), and when the UpTPS is defined by two SC-FDMA symbols, a Physical Random Access Chanel (PRACH) may be transmitted.

FIG. 7 is a conceptual diagram illustrating an operation of the TDD system according to the exemplary embodiment of the present invention.

Referring to FIG. 7, one or more SC-FDMA symbols may be allocated to a UpTPS 700. When the UpTPS 700 is defined by one SC-FDMA symbol, the user equipment may transmit only the SRS, and when the UpTPS 700 is defined by two SC-FDMA symbols, the PRACHS may be transmitted.

As described above, the reduced guard period may be used or the guard period may not be used according to a position of the user equipment within the cell or the cell operation method. The user equipment may receive information about the SC-FDMA symbol used through a higher layer (for example, SIB by the RRC). The base station may dynamically allocate the information about the SC-FDMA symbol used to the UpTPS 700 based on a control channel, such as the PDCCH. For example, the base station may additionally insert a bit notifying a resource size of the downlink of the special subframe into a DCI of the PDCCH and transmit the PDCCH to the user equipment. As another method, the base station may transmit information indicating the number of reduced or added symbols to the user equipment based on a format of a subframe used in the TDD system defined by the SIB.

When the base station transmits a message (a message indicating the number of symbols to be reduced) for reducing a length of the guard period to each user equipment, each user equipment may analyze a time at which uplink is transmitted and a time at which increased downlinks arrive, and determine whether to accept a change in a length of the guard period. For example, when the reduced guard period mode or the zero guard period mode is used, the base station may transmit information about the reduced guard period based on the default guard period to the user equipment. Further, the base station may receive information about whether the user equipment accepts the reduced guard period from the user equipment.

Whether to allocate a downlink resource may be determined based on a reference user equipment in which a first time, at which downlink data arrives the user equipment from the base station, is the same as a second time, at which the user equipment transmits the uplink data to the base station. The reference user equipment may be virtual user equipment. For user equipment located at a far position than the reference user equipment based on the base station, the downlink resource may not be allocated to the corresponding user equipment.

Otherwise, user equipment having a larger value of the TA than that of the user equipment having the same time of arrival of the downlink data as the time of the transmission of the uplink data to the base station may be user equipment in which reception of the downlink data transmitted from the base station is restricted.

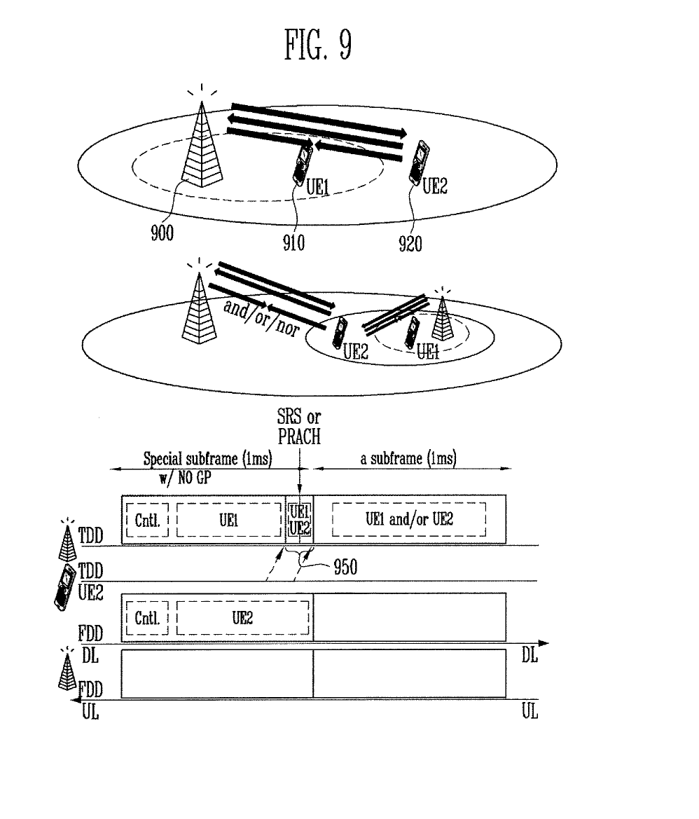

FIG. 8 is a conceptual diagram illustrating a data transmission and reception method between user equipment and a base station in the TDD system according to the exemplary embodiment of the present invention.

Referring to FIG. 8, distances from a base station 800 may be increased in a sequence of first user equipment 810, second user equipment 820, and third user equipment 830.

In FIG. 8, a case where a length of a GP is set to a decreased length of a GP is assumed. In this case, there is no problem in the first user equipment 810 and the second user equipment 820, but for the third user equipment 830, a time at which downlink transmission is performed overlap a time at which uplink transmission is performed. Accordingly, the third user equipment 830 may not perform partial downlink transmission or may be restricted in the reception of downlink data.

When the third user equipment 830 performs uplink transmission, the third user equipment 830 performs uplink transmission by delaying TA having a predetermined value at which the downlink is received as illustrated by a green solid line 850. In this case, the base station 800 may not cause interference with the downlink data transmitted to the second user equipment 820.

For the third user equipment 830, the allocation of the downlink resource to the third user equipment 830 in the special subframe may be restricted, but the third user equipment may also receive the downlink data only through some downlink resources. For example, the third user equipment 830 may receive only a control message of the downlink or use only a predetermined symbol through the ePDCCH. The third user equipment 830 may perform the uplink transmission through the special subframe without the allocation of some downlink resources.

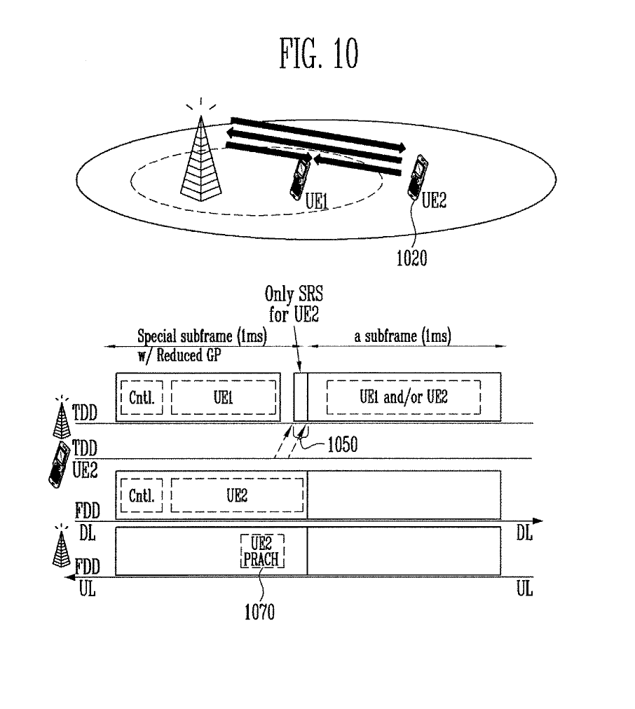

FIGS. 9 and 10 are conceptual diagrams illustrating communication between a base station and user equipment supporting FDD and TDD according to an exemplary embodiment of the present invention.

FIGS. 9 and 10 illustrate the case where an LTED system based on TDD and an LTE system based on FDD are simultaneously implemented in a base station and user equipment.

When the TDD and the FDD are simultaneously operated for data transmission and reception, data is transmitted and received by the TDD for user equipment in which a guard period may be minimized in the special subframe, and data may be transmitted and received based on the FDD for the remaining user equipment.

For example, data is transmitted and received by the TDD by operating the special subframe by using a reduced guard period or without using a guard period for first user equipment 910 closely located to a base station 900.

In this case, the TDD based uplink/downlink transmission may be performed between the base station 900 and the first user equipment 910. As described above, when one SC-FDMA symbol or two SC-FDMA symbols are allocated to a UpTPS 950, the user equipment 910 may transmit an SRS or a PRACH. Since second user equipment 920 is far from the base station 900, data transmission and reception may be performed between the base station 900 and the user equipment 920 based on the FDD scheme without using the TDD scheme.

That is, the second user equipment 920 requiring the relatively longer RTT in order to perform transmission and reception with the base station 900 may perform downlink transmission based on the FDD without allocating the downlink resource to the special subframe of the TDD.

FIG. 10 illustrates a method of transmitting an SRS when one SC-FDMA symbol is allocated to a UpTPS 1050 of second user equipment 1020. Further, user equipment operated based on the FDD system may obtain information on a distance between the user equipment and the base station by transmitting a PRACH 1070.

According to another exemplary embodiment of the present invention, a location of user equipment may be estimated by a PRACH signal transmitted by the user equipment. The PRACH is a channel used for performing random access to the base station by the user equipment.

As described above, when the number of SC-FDMA symbols allocated as uplink resources of the special subframe is two, the user equipment may transmit the PRACH signal or the SRS, and when the number of SC-FDMA symbols allocated is one, the user equipment may transmit only the SRS.

When the user equipment first transmits the PRACH signal, a distance between the user equipment and the base station may be inferred through a value of the TA. The base station and the user equipment may exchange information indicating whether to support the use of the reduced guard period or non-use of the guard period.

When the user equipment moves, the user equipment periodically transmits the PRACH signal, so that the base station may continuously observe the value of the TA. The TA performed by the PRACH signal in the LTE may have a range adjustable to 8 bits by the unit of Ts of 0.52 us.

The distance between the user equipment and the base station may be determined by various methods, as well as a location determination method based on the PRACH. For example, location information about the user equipment may be obtained from a system, such as a Cognitive Radio (CR) system, which needs to transmit location information about the user equipment to the base station, or a Global Positioning System (GPS).

According to another exemplary embodiment of the present invention, the switch between the uplink and the downlink may be freely performed in the TDD system. In the existing TDD based LTE system, the switch between the uplink and the downlink is minimized according to a burden of a guard period. However, when the reduced guard period is used or a guard period is not used, the burden of the guard period is relatively decreased, so that the switch between the downlink and the uplink may become relatively free within one frame.

According to another exemplary embodiment of the present invention, data may be transmitted and received through one duplexing method between the TDD and the FDD based on information on a distance between the base station and the user equipment. Particularly, user equipment capable of using one of the reduced guard period mode and the zero guard period mode based on location information about user equipment may transmit and receive data with the base station based on the TDD. By contrast, user equipment, in which one of the reduced guard period mode and the zero guard period mode based on location information about user equipment is not usable (that is, when a default guard period needs to be used), may transmit and receive data with the base station based on the FDD, not the TDD.

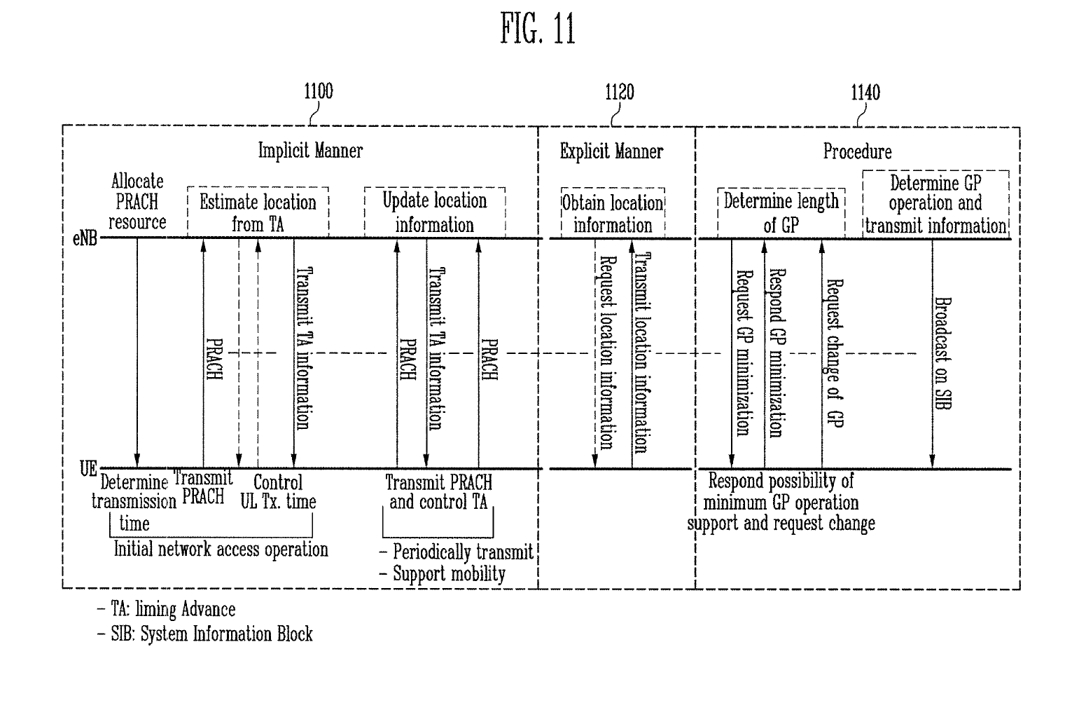

FIG. 11 is a conceptual diagram illustrating a method of determining a length of a guard period according to a position of user equipment according to an exemplary embodiment of the present invention.

Referring to FIG. 11, a base station may receive location information from user equipment by various methods.

Referring to a left part 1100 of FIG. 11, it is illustrated a method of obtaining, by a base station, location information from user equipment based on an implicit method.

First, a base station may allocate an PRACH resource to user equipment. The user equipment receiving the PRACH resource may transmit the PRACH to the base station. The base station may recognize TA and location information about the user equipment based on the received PRACH. The base station may transmit information on the TA to the user equipment. The location information may be updated by the base station based on the PRACH periodically transmitted from the user equipment after initial access to a network.

Referring to a center part 1120 of FIG. 11, it is illustrated a method of obtaining, by a base station, location information from user equipment based on an explicit method. The base station may directly request location on the user equipment from the user equipment. The user equipment may receive the request for the location information from the base station, and transmit information on a location thereof.

A right part 1140 of FIG. 11 illustrates a method of transmitting and receiving information related to a GP between a base station and user equipment.

The base station may receive information about whether the user equipment may use a GP minimizing method (a method of using the TDD when the zero guard period or the reduced guard period mode is supportable, or a method of using the FDD in other cases). For example, the base station may confirm whether the user equipment may support the GP minimizing method in the user equipment through signaling with the user equipment.

When the GP minimizing method is available in the user equipment, the base station may determine a GP operating method and transmit information on the determined GP operating method to the user equipment.

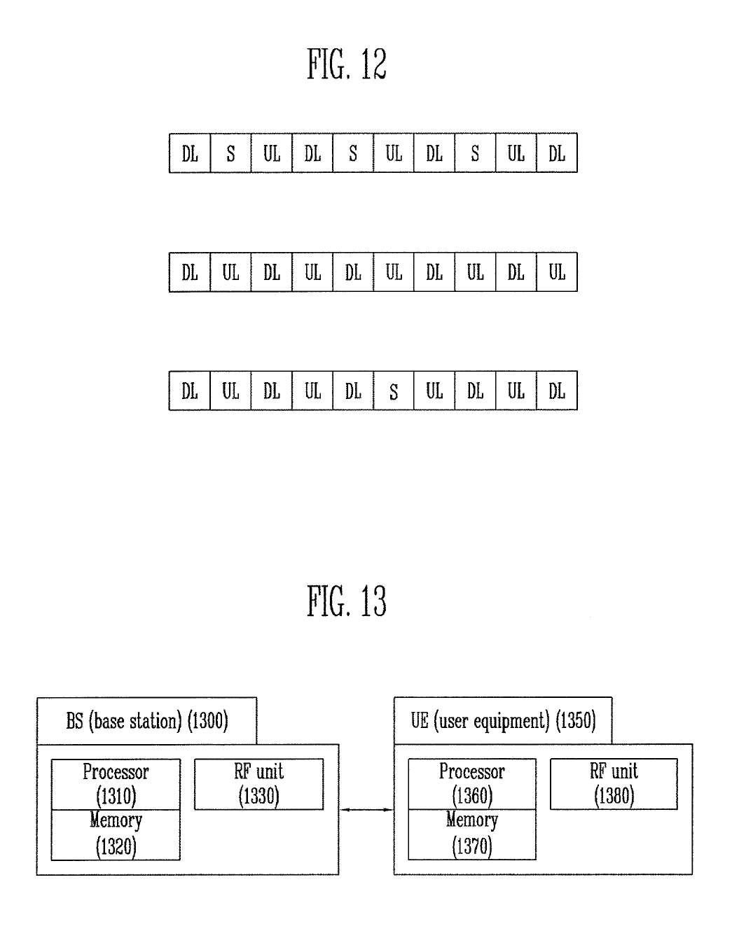

FIG. 12 is a conceptual diagram illustrating a frame structure according to an exemplary embodiment of the present invention.

Referring to FIG. 12, the TDD system may define a frame with various structures, compare to an existing frame structure.

Since a burden of the GP occupied in the existing special subframe is decreased in the frame structure according to the exemplary embodiment of the present invention, the number of the special subframes may be defined to be the relatively greater number than that of the special subframes included in the existing frame.

In FIG. 12, DL indicates a downlink subframe, UL indicates an uplink subframe, and S indicates a special subframe.

An upper end of FIG. 12 indicates a frame structure when a reduced guard period is used.

Like the frame at the upper end of FIG. 12, the number of special subframes may be 3. The reduced guard period may be used in each special subframe.

A center end of FIG. 12 indicates a frame structure when a guard period is not used.

According to the exemplary embodiment of the present invention, a frame structure using no guard period may also be defined. When the guard period is not used in the frame, relatively much switching may be performed between the uplink transmission and the downlink transmission of the frame. When a guard period is not present, the uplink transmission and the downlink transmission may be switched and performed based on a boundary of the subframes included in the frame without separately defining a special subframe.

A lower end of FIG. 12 illustrates a frame structure when the reduced guard period is used and the guard period is not used. The frame structure according to the exemplary embodiment of the present invention may have a frame format in which the case where the reduced guard period and the guard period is not used is mixed.

By using the frame structure of FIG. 12, it is possible to minimize an ACK/NACK latency problem existing in the TDD System, and simplify a resource allocation rule. Further, when a network for a service, such as Machine to Machine (M2M) or Internet of Things is configured, it is adaptively control a frame structure of the TDD based on the reduced guard period.

A level of performance improvement according to an operation of a minimized guard period according to the exemplary embodiment of the present invention is variable according to an actual cell operation. However, when it is assumed that a base station and all of user equipment use the same Modulation Coding Scheme (MCS) in a system bandwidth of 5 MHz without considering a reference signal and a synchronization signal, a transmission rate of encoded data may be increased by up to 14% depending on the number of OFDM symbols used as the guard period.

FIG. 13 is a block diagram illustrating a wireless communication system according to an exemplary embodiment of the present invention.

Referring to FIG. 13, a base station 1300 includes a processor 1310, a memory 1320, and a Radio Frequency (RF) unit 1330. The memory 1320 is connected with the processor 1310 to store various elements of information for driving the processor 1310. The RF unit 1320 is connected with the processor 1310 to transmit and/or receive the radio signal. The processor 1310 implements the suggested function, process, and/or method. In the aforementioned exemplary embodiment, the operation of the base station may be implemented by the processor 1310.

For example, the processor 1310 may determine a guard period based on information on a distance between user equipment and the base station, and perforin downlink transmission to the user equipment based on the determined guard period. The guard period may be determined based on one of the default guard period mode, the reduced guard period mode, and the zero guard period mode, and the reduced guard period mode may be a mode for setting a reduced guard period, which is shorter than the default guard period, set based on the default guard period mode, and the zero guard period mode may be a mode for setting a length of the guard period to 0.

A wireless device 1350 includes a processor 1360, a memory 1370, and an RF unit 1380. The memory 1370 is connected with the processor 1360 to store various elements of information for driving the processor 1360. The RF unit 1380 is connected with the processor 1360 to transmit and/or receive the radio signal. The processor 1360 implements the suggested function, process, and/or method. In the aforementioned exemplary embodiment, the operation of the wireless device may be implemented by the processor 1360.

For example, when the reduced guard period mode or the zero guard period mode is used, the processor 1360 may be implemented so that information about the reduced guard period based on the default guard period is received from the base station. Further, the processor 1360 may transmit information about whether to accept the reduced guard period to the base station.

The processor may include an Application-Specific Integrated Circuit (ASIC), other chipsets, a logic circuit, and/or a data processing device. The memory may include a Read-Only Memory (ROM), a Random Access Memory (RAM), a flash memory, a memory card, a storage medium, and/or another storage device. The RF unit may include a baseband circuit for processing a radio signal. When an exemplary embodiment is implemented by software, the aforementioned technique may be implemented by a module (a process, a function, and the like) that performs the aforementioned function. The module may be stored in the memory, and executed by the processor. The memory may be located inside or outside the processor, and may be connected with the processor through well-known various means.

In the aforementioned exemplary system, the methods are described based on a flowchart including the series of steps or the blocks, but the present invention is not limited to the sequences of the steps, and a specific step may be generated with another step with a different sequence or at the same time. Further, those skilled in the art may understand that the steps illustrated in the flowchart are not exclusive, and another step may be included, or one or more steps in the flowchart may be omitted without influencing the scope of the present invention.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A communication method based on Time Division Duplexing (TDD), comprising:
determining, by a base station, a guard period based on information on a distance between user equipment and the base station; and
performing, by the base station, downlink transmission to the user equipment based on the determined guard period,
wherein the guard period is determined based on one of a default guard period mode, a reduced guard period mode, and a zero guard period mode, and
the reduced guard period mode is a mode for setting a reduced guard period, which is shorter than the default guard period set based on the default guard period mode, and
the zero guard period mode is a mode for setting a length of the guard period to 0.

2. The communication method of claim 1, wherein when the guard period is the reduced guard period, the base station determines a downlink resource allocated for the downlink transmission based on the information on the distance between the user equipment and the base station.

3. The communication method of claim 1, wherein when the guard period is the reduced guard period or a guard period having a length of 0, the base station transmits special subframe format information,
the special subframe format information includes information about a frame to which the reduced guard period mode or the zero guard period mode is applied, and
the special subframe format information includes information about a special subframe, in which the reduced guard period mode or the zero guard period mode is used, among the special subframes included in the frame.

4. The communication method of claim 3, wherein when the number of special subframes is plural, lengths of the guard periods defined in the respective special frames among the special subframes have different values.

5. The communication method of claim 1, wherein a size of the reduced guard period is set based on a Round Trip Time (RTT) of the user equipment.

6. The communication method of claim 1, further comprising:
when the reduced guard period mode or the zero guard period mode is used, transmitting, by the base station, information about a reduced guard period based on the default guard period to the user equipment, and
receiving, by the base station, information about whether the user equipment accepts the reduced guard period, from the user equipment.

7. A base station performing a communication method based on TDD, comprising:
a Radio Frequency (RF) unit configured to transmit or receive a radio signal; and
a processor selectively connected with the RF unit to be operated,
wherein the processor determines a guard period based on information on a distance between user equipment and the base station, and performs downlink transmission to the user equipment based on the determined guard period, and
the guard period is determined based on one of a default guard period mode, a reduced guard period mode, and a zero guard period mode, and
the reduced guard period mode is a mode for setting a reduced guard period, which is shorter than the default guard period set based on the default guard period mode, and
the zero guard period mode is a mode for setting a length of the guard period to 0.

8. The base station of claim 7, wherein when the guard period is the reduced guard period, the processor determines a downlink resource allocated for the downlink transmission based on the information on the distance between the user equipment and the base station.

9. The base station of claim 7, wherein when the guard period is the reduced guard period or a guard period having a length of 0, the base station transmits special subframe format information,
the special subframe format information includes information about a frame to which the reduced guard period mode or the zero guard period mode is applied, and
the special subframe format information includes information about a special subframe, in which the reduced guard period mode or the zero guard period mode is used, among the special subframes included in the frame.

10. The base station of claim 9, wherein when the number of special subframes is plural, lengths of the guard periods defined in the respective special frames among the special subframes have different values.

11. The base station of claim 7, wherein a size of the reduced guard period is set based on a Round Trip Time (RTT) of the user equipment.

12. The base station of claim 7, wherein when the reduced guard period mode or the zero guard period mode is used, the processor transmits information about a reduced guard period based on the default guard period to the user equipment, and receives information about whether the user equipment accepts the reduced guard period from the user equipment.

13. A communication method based on Frequency Division Duplexing (FDD) and TDD, comprising:
determining, by a base station, a guard period based on information on a distance between user equipment and the base station;
when the determined guard period is a reduced guard period or a zero guard period, performing, by the base station, downlink transmission to the user equipment based on the TDD; and
when the determined guard period is a default guard period, performing, by the base station, downlink transmission to the user equipment based on the FDD,
wherein the reduced guard period is a guard period shorter than the default guard period, and
in the zero guard period, the guard period has a length of 0.

14. The communication method of claim 13, wherein the information on the distance is obtained based on a Physical Random Access Channel (PRACH) received from the user equipment, or location information transmitted by the user equipment in response to a request for the location information transmitted by the base station.

15. The communication method of claim 13, further comprising:
transmitting, by the base station, information about a guard period mode used by the base station.
